(19) United States
(12) Patent Application Publication
(10) Pub. No.: US 2005/0213116 A1
(43) Pub. Date: Sep. 29, 2005

(54) Print processing device, print processing method, print processing storage medium, and printing system

(75) Inventor: Hiroyoshi Uejo, Ebina-shi (JP)

Correspondence Address: OLIFF & BERRIDGE, PLC, P.O. BOX 19928, ALEXANDRIA, VA, 22320, US

(73) Assignee: FUJI XEROX CO., LTD., Minato-ku (JP)

(21) Appl. No.: 10/961,235

(22) Filed: Oct. 12, 2004

(30) Foreign Application Priority Data
Mar. 24, 2004 (JP) 2004-87089

(51) Int. Cl. G06F 15/00

(52) U.S. Cl. 358/1.1; 358/1.15

(57) ABSTRACT

A print processing device in a printing system for processing a print job based on instructions and which processes at least a portion of the processing. The print processing device includes determination and output sections. The determination section determines whether a first processing device is capable of executing subsequent processing. When the first processing device is capable of executing, the output section outputs the print instruction to the first processing device, and when not capable, the output section outputs, to a second substitute processing device, a print instruction having a description format corresponding to the substitute processing device.

### CROSS-REFERENCE TO RELATED APPLICATION

This application claims priority under 35 USC 119 from Japanese Patent Application No. 2004-87089, the disclosure of which is incorporated by reference herein.

### BACKGROUND OF THE INVENTION

1. Field of the Invention

The present invention relates to a print processing device, a print processing method, a print-processing storage medium, and a printing system. More specifically, the present invention relates to a print processing device, a print processing method, a print-processing storage medium, and a printing system, in which multiple printing processes are performed. The print processing device uses, for example, a printing plate, or an image forming device having a printing function for forming an image on a storage medium with an electrophotographic printer or the like.

2. Description of the Related Art

In conventional printing (e.g., offset printing), an intermediate product such as printed paper for phototypesetting (i.e., photographic printing paper), block copy, halftone negative, halftone positive, a PS plate (a printing plate), or the like is generated, and operations such as printing and bookbinding are carried out based on these intermediate products.

As shown in FIG. 7, for example, a printing operation is composed of an imposition process, an RIP process, a CTP process, a printer process, a folding-machine process, a cutting-machine process, and a binding-machine process. In the imposition process, the positions of images are determined by layout, and in the RIP process, image data for printing is prepared by layout data. In the CTP process, a printing plate is prepared from the image data, and in the printer process, printing is carried out using the printing plate. In the folding-machine process, folding is carried out for a printed medium in accordance with print specifications, and in the cutting-machine process, the medium having been subjected to folding after printing is cut in accordance with print specifications. In the binding-machine process, binding is carried out for the medium having been subjected to folding and cutting after printing in accordance with print specifications. These processes for printing are each provided separately from one another, and are each carried out independently.

In recent years, “direct printing” or “on-demand printing” which allows printing directly from DTP data has become widely-known with the popularization of desktop publishing/prepress (DTP). DTP is a popular technique in which print data obtained by processing a page layout on a computer is formed on paper such as photographic printing paper or process film. A printing plate is prepared based on the print data, and a printing operation is carried out using the printing plate. Further, computer-to-plate (CTP) in which a printing plate is formed directly from electronic data without producing an intermediate product, has also attracted much attention. Known image-forming devices that can be used for such print processing include those having the print functions of a printer, a copying machine, and the like.

Although the aforementioned DTP technique enables distribution of electronic data in certain steps of print processing on the periphery of the image forming device, it cannot be used in all steps of print processing. Further, it has been difficult to use the DTP technique in conventional printing processes.

CIP4 has been proposed by Heidelberg Druckmaschinen AG as a control method for automating print workflow. Printing equipment vendors, as well as companies that provide pre-press and post-press services, are adjusting their operations in response to CIP4. As a result, printing operations that have conventionally been carried out manually have become semi-automated, whereby instructions ranging from the abstract to the detailed, regarding image processing and the like, are given to devices.

In recent years, printing and electrophotography have been combined as can be seen in digital color proofing using printers or in on-demand printing. Under current circumstances, however, automation of workflow is carried out by giving instructions to devices based on an individual or separate standards. This has been necessary due to the differences in workflow between regular printing and electrophotography.

### SUMMARY OF THE INVENTION

The present invention has been devised in view of the aforementioned circumstances and provide a print processing device, a print processing method, a print-processing storage medium, and a printing system that allow combination of a printing system in which multiple printing processes are performed, such as using a printing plate, and an image forming system that forms an image on a recording medium using an electrophotographic printer or the like.

A first aspect of the present invention is to provide a print processing device which processes at least a portion of a printing process in a printing system for processing a print job based on a print instruction in which request items in a printing process for obtaining a printed matter are described in a predetermined description format, the print processing device including: a determination section that, based on the print instruction acquired from a previous process, determines whether a first processing device that is to perform a subsequent process is capable of executing processing; and an output section that, when the first processing device that is to process a subsequent process is capable of executing processing, outputs the print instruction to the first processing device that is to process a subsequent process, and when the first processing device is not capable of executing processing, outputs, to a second processing device that can be substituted for the first processing device, a print instruction corresponding to the substituted second processing device.

The printing system processes a print job based on a print instruction in which request items in a printing process for obtaining a printed matter can be described by a predetermined description format. The first description format can describe information concerning, for example, procedures of the printing process using a printing plate.

A second aspect of the present invention is to provide a print processing device which processes at least a portion of a printing process in a printing system for processing a print job based on a first print instruction in which request items in a printing process for obtaining a printed matter are described in a first description format, or on a second print instruction in which request items are described in a second description format that differs from the first description format, the print processing device including: an interpretation section that interprets the first print instruction acquired from a previous process; a determination section that outputs the first print instruction to a first processing device responsible for a predetermined process, and after completion of processing by the first processing device, determines whether a first processing device that is to perform a subsequent process is capable of executing processing; and an output section that, when the first processing device that is to perform a subsequent process is capable of executing processing, outputs the first print instruction to the first processing device that is to perform a subsequent process, and when the first processing device that is to perform a subsequent process is not capable of executing processing, outputs the second print instruction to a second processing device that is capable of executing processing that is at least substantially the same as subsequent processing and that interprets the second print instruction and executes a predetermined process.

A third aspect of the present invention is to provide a print processing method which processes at least a portion of a printing process in a printing system for processing a print job based on a print instruction in which request items in a printing process for obtaining a printed matter are described in a predetermined description format, the print processing method including: determining whether a first processing device that is to perform a subsequent process is capable of executing processing based on the print instruction acquired from a previous process; and outputting the print instruction to the first processing device that is to perform a subsequent process when the first processing device is capable of executing processing, and when the first processing device is not capable of executing processing, outputting, to a second processing device that can be substituted for the first processing device, a print instruction having a description format corresponding to the substitute second processing device.

A fourth aspect of the present invention is to provide a print processing method which processes at least a portion of a printing process in a printing system for processing a print job based on a first print instruction in which request items in a printing process for obtaining a printed matter are described in a first description format, or on a second print instruction in which the request items are described in a second description format that differs from the first description format, the print processing method including: interpreting the first print instruction acquired from a previous process; outputting the first print instruction to a first processing device responsible for a predetermined process, and after completion of processing by the first processing device, determining whether a first processing device that is to perform a subsequent process is capable of executing processing; and when the first processing device that is to perform the subsequent process is capable of executing processing, outputting the first print instruction to the first processing device that is to perform the subsequent process, and when the first processing device that is to perform the subsequent process is not capable of executing processing, outputting the second print instruction to a second processing device that is capable of executing processing that is at least substantially the same as subsequent processing and that interprets the second print instruction and executes a predetermined process.

Due to the print processing method described above, even when the processing device responsible for the subsequent process is not capable of executing processing, the processing can be alternatively executed by other alternative device.

A fifth aspect of the present invention is to provide a computer-readable storage medium storing a print processing program executable by a computer to process at least a portion of the printing process in a printing system for processing a print job based on a print instruction in which request items in a printing process for obtaining a printed matter are described in a predetermined description format, the processing including: determining whether a first processing device that is to perform a subsequent process is capable of executing processing based on the print instruction acquired from a previous process; and outputting the print instruction to the first processing device when the first processing device is capable of executing, and when the first processing device is not capable of executing, outputting to a second processing device that can be substituted for the first processing device a print instruction having a description format corresponding to the substitute second processing device.

A sixth aspect of the present invention is to provide a computer-readable storage medium storing a print processing program executable by a computer to process at least a portion of a printing process in a printing system for processing a print job based on a first print instruction in which request items in a printing process for acquiring a printed matter are described by a first description format, or on a second print instruction in which request items are described by a second description format that differs from the first description format, the print processing including: interpreting the first print instruction acquired from a previous process; outputting the first print instruction to a first processing device responsible for a predetermined process, and after completion of processing by the first processing device, determining whether a first processing device that is to perform a subsequent process is capable of executing processing; and outputting the first print instruction to the first processing device that is to perform the subsequent process when the first processing device that is to perform the subsequent process is capable of executing, and when the first processing device that is to perform the subsequent process is not capable of executing, outputting the second print instruction to a second processing device that is capable of executing processing that is at least substantially the same as subsequent processing and that interprets the second print instruction and executes a predetermined process.

A seventh aspect of the present invention is to provide a printing system for processing a print job based on a print instruction in which request items in a printing system for obtaining a printed matter are described by a predetermined description format, the printing system including: a plurality of processing devices for processing at least a portion of the printing process, wherein the print processing devices being connected to each other, each print processing device includes: a determination section that, based on the print instruction acquired from a previous process, determines whether a first processing device that is to perform a subsequent process is capable of executing processing; and an output section that, when the first processing device is capable of executing processing, outputs the print instruction to the first processing device, and when the first processing device is not capable of executing processing, outputs to a second processing device that can be substituted for the first processing device, a print instruction corresponding to the substitute second processing device.

An eighth aspect of the present invention is to provide a printing system for processing a print job based on a print instruction in which request items in a printing process for obtaining a printed matter are described by a predetermined description format, the printing system including: a plurality of printing processing devices for processing at least a portion of the printing process, wherein the print processing devices being connected to each other, each print processing device includes: an interpretation section that interprets the first print instruction acquired from a previous process; a determination section that outputs the first print instruction to a first processing device responsible for a predetermined process, and after completion of processing by the first processing device, the determination section determines whether or not a first processing device that is to perform a subsequent process is capable of executing processing; and an output section that, when the first processing device that is to perform a subsequent process is capable of executing processing, outputs the first print instruction to the first processing device that is to perform a subsequent process, and when the first processing device that is to perform a subsequent process is not capable of executing processing, outputs the second print instruction to a second processing device that is capable of executing processing that is at least substantially the same processing as subsequent processing and that interprets the second print instruction and executes a predetermined process.

Due to the printing system described above, even when the processing device responsible for the subsequent process is not capable of executing processing, the processing can be alternatively executed by other alternative device.

### BRIEF DESCRIPTION OF THE DRAWINGS

Embodiments of the present invention will be described in detail based on the following figures, wherein:

FIG. 1 is a block diagram showing the structure of a print processing system according to an embodiment of the present invention;

FIG. 2 is a block diagram showing a basic structure of each of devices forming the print processing system according to the embodiment of the present invention;

FIG. 3 is a block diagram illustrating the mutual relationship between the devices forming the print processing system according to the embodiment of the present invention;

FIGS. 4A to 4D are image diagrams each showing the structure of print instruction and a flow of data addition in the present embodiment: FIG. 4A shows only a basic field; FIG. 4B shows a field including specifications required by a user; FIG. 4C shows a field including specifications for each printing-related process; and FIG. 4D shows a field including detailed specifications for each printing-related process;

FIG. 5 is a process flow chart for linkage processing starting from a request for a printed matter to the end by obtaining the printed matter in the present embodiment;

FIG. 6 is a process flow chart for processing that is carried out by a processing device responsible for one printing-related process in the present embodiment;

FIG. 7 is a diagram showing the flow of a conventional printing process;

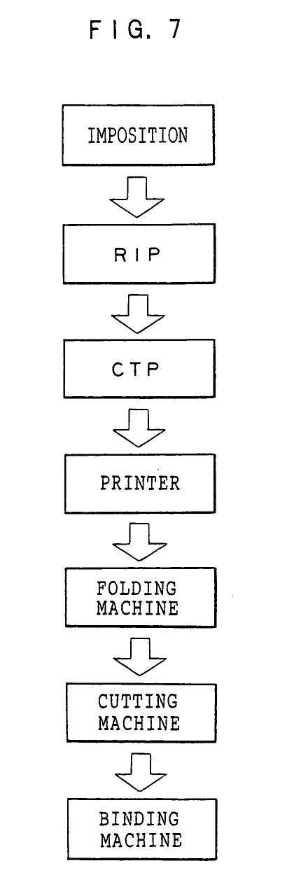

FIG. 8 is a flow chart showing the process flow of an example of workflow combination of printing and electrophotographic operations in the present embodiment; and

FIG. 9 is a diagram showing an example of the process flow in the present embodiment.

### DETAILED DESCRIPTION OF THE INVENTION

Referring now to the attached drawings, the mode for carrying out the present invention will be hereinafter described in detail.

[System Configuration]

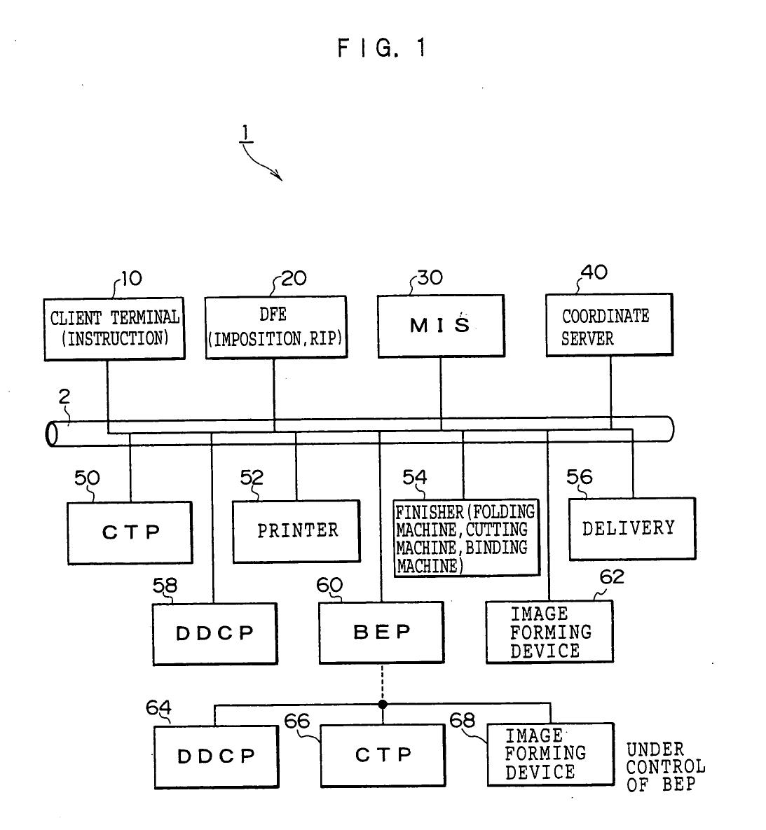

FIG. 1 is a block diagram showing the structure of a print processing system 1 according to an embodiment of the present invention.

The print processing system 1 is structured in such a manner that various devices for enabling a variety of services related to print processing are connected via a network 2. Here, services generally refer to printing-related functions that can be used in response to external requests or orders. Examples of the services include creation of layout data, imposition, data conversion, printing plate preparation, printing, folding, cutting, binding and the like, but are not limited thereto.

Specifically, the print processing system 1 includes a client terminal 10 having a user interface for giving an instruction for print processing in which a printed matter requested by a user is finally obtained through multiple services, a digital front end processor (DFE) device 20, a management information system (MIS) device 30, a coordinate server 40, a computer to plate (CTP) device 50, a printer 52, a finisher device 54 and a delivery management device 56.

The DFE device 20 is a device that passes print data to an image forming device such as a CTP or a printer and gives a printing instruction thereto. The MIS device 30 is a device for controlling a device responsible for service processing in accordance with a print instruction (a first print instruction). The first print instruction contains a description of information related to the service procedure instructed at the client terminal 10 having a predetermined description format (for example, Job Definition Format or JDF). The coordinate server 40 is a device for controlling a node of a device or a program, which is responsible for executing service processing in accordance with a print instruction (a second print instruction). The second print instruction has a description of information related to service coordination instructed at the client terminal 10, having other description format. These print instructions described in these description formats can be expressed in a predetermined language (for example, Extensible Markup Language or XML). That is, a print instruction can be prepared by expressing a predetermined description format or other description format using XML. The aforementioned language is not limited to XML.

The CTP device 50 is a device that forms a printing plate directly from print data without producing an intermediate product. The printer 52 is a device that carries out printing using the printing plate formed by print data. Further, the finisher device 54 is a device in which a printed matter requested by a user (for example, after binding) is obtained by folding, cutting and binding printed papers. The delivery management device 56 is a device that manages processing for delivering the printed matter to the hands of a user.

The MIS device 30 is a device for controlling a device responsible for executing service processing in accordance with a print instruction having a predetermined description format (for example, JDF), but in the present embodiment, it has a management function for managing the entire print processing system 1. Accordingly, the MIS device 30 has the function of enabling preparation of a print instruction described by a format other than a predetermined description format such as JDF.

Further, a digital direct color proofing (DDCP) device 58, a back end processor (BEP) device 60, and an image forming device 62 are connected to the network 2. The image forming device 62 is a device having a so-called printing function of forming an image on a storage medium using an electrophotographic system, for example, a color copying machine, a facsimile machine, or a printer. The image forming device 62 can be made into a device that includes the function of the above finisher device 54. The DDCP device 58 may be an output device that outputs a print for color proofing directly from DTP data, or an output device that outputs a large-sized print imposed for plate-making. The BEP device 60 is a device having function of performing various processing for data of which print data based on a client's instruction has been converted into raster data (subjected to RIP processing). The BEP device 60 can be connected to various output devices: a DDCP device 64 similar to the aforementioned DDCP device 58; a CTP device 66 similar to the aforementioned CTP device 50; an image forming device 68 similar to the aforementioned image forming device 62; and the like. That is, any one or more of the DDCP device 64, the CTP device 66 and the image forming device 68 can be connected to the BEP device 60 under the control of the BEP device 60.

The coordinate server 40 can have a system configuration for realizing service coordination by including a service search server for searching for services requested by a user, an instruction preparation server for preparing a print instruction from information concerning service coordination instructed at the client terminal 10, an instruction management server for managing a print instruction, and a coordination processing server that executes coordination processing of various services in accordance with a print instruction. Further, the coordinate server 40 can also be provided with an image processing device that performs image processing for an image document such as noise reduction processing, image rotating processing, optical character recognition (OCR) processing, and binding of an image, a document management server for managing a document, a document distribution server for distributing a document, and a service processing device that performs predetermined service processing.

The service coordination mentioned herein refers to a relationship between services such that a service to be started subsequently is determined based on the result of an arbitrary service, or an arbitrary service exerts influence on the operation of a subsequent service. The mention of services herein refers to functions related to print processing, which can be used at an external request. Examples of the services include copying, printing, scanning, facsimile transmission/reception, mail distribution, storage in a repository or reading from a repository, OCR processing, noise reduction processing and the like, but are not particularly limited thereto. Accordingly, the coordinate server 40 is provided so as to give instructions and manage print processing requested by a user with multiple services being coordinated together, and is made to execute coordination processing of various services in accordance with a print instruction using information concerning service coordination based on a print instruction.

Further, in the present embodiment, the print processing system 1 is configured such that multiple devices that carry out predetermined printing-related processing are connected via the network 2. However, as long as multiple services are connected via the network 2, the present invention is not particularly limited to this structure.

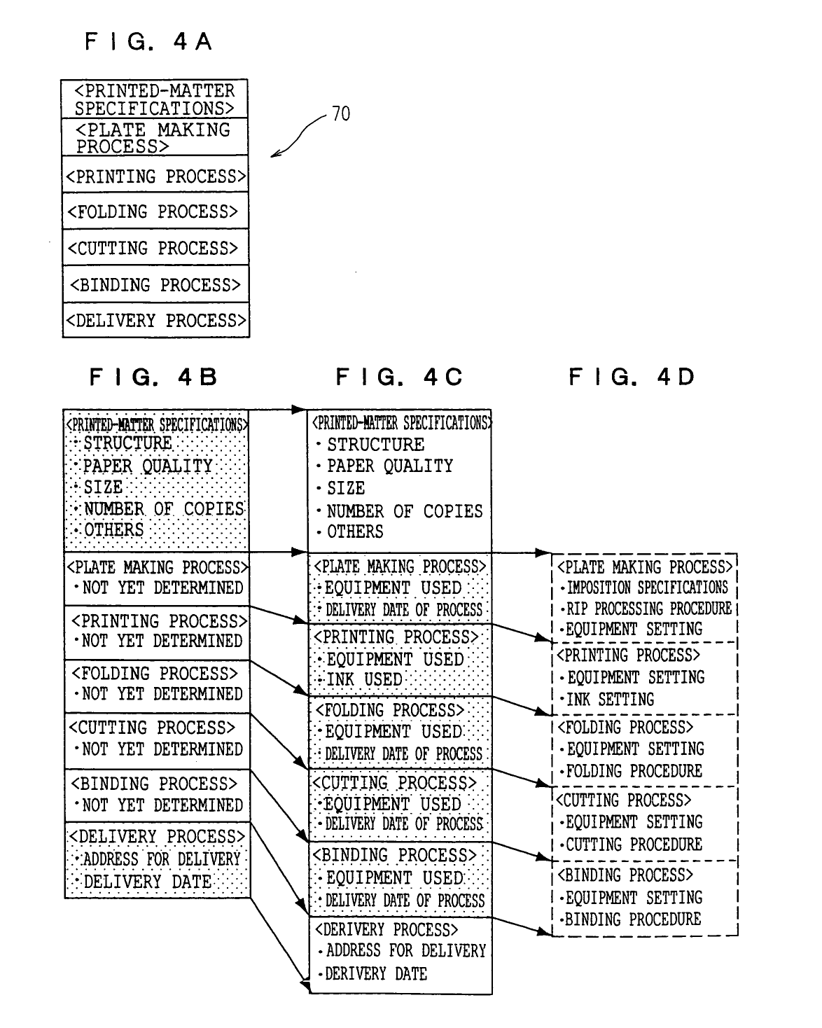

The print instruction mentioned herein means data which, in a case in which a series of processing related to printing are divided into multiple functional processes, includes information representing the relationship between these processes, and parameter information utilized in the function carried out in each process. The print instruction is described in a predetermined description format, for example, JDF (see FIGS. 4A to 4D).

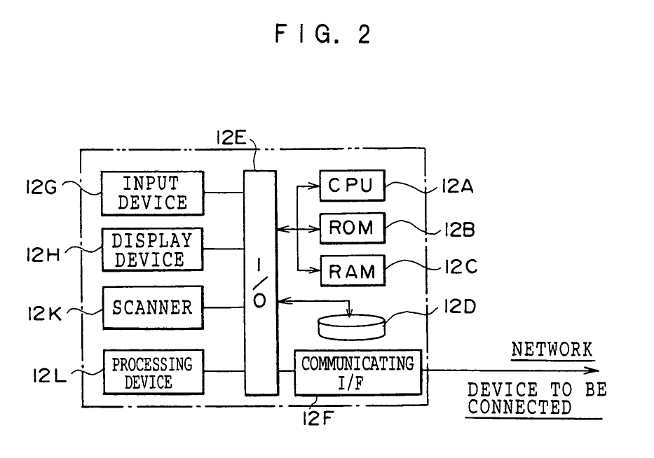

FIG. 2 shows the entire client terminal 10 as an example of the basic structure of each of the devices that constitute the print processing system 1. The client terminal 10 has at least CPU 12A, and the CPU 12A is connected to an input/output bus (in FIG. 2, I/O) 12E. Further, ROM 12B and RAM 12C are provided as elements related to the CPU 12A. Connectable to the input/output bus 12E are an input device 12G such as a keyboard or a mouse, a display device 12H such as a display, and a scanner device 12K for reading an image. Also connectable to the input/output bus 12E are a processing device 12L such as a printer or a proofer, which realizes a processing function by its own device, and a communication interface 12F to be connected to the network 2 or a device to be connected (a local host).

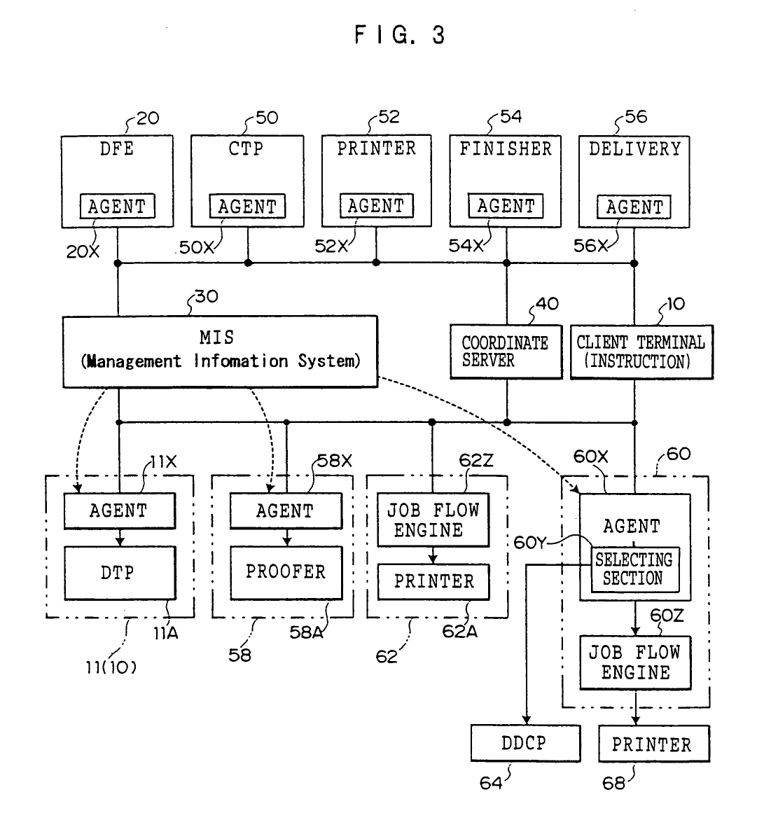

Due to the hardware resource having the aforementioned structure, and the software resource that is a processing program stored in the ROM 12B or the RAM 12C, the devices that constitute the print processing system 1 are activated. The devices that constitute the print processing system 1 each have an agent-function section for interpreting a print instruction with the hardware resource and the software resource used (see FIG. 3). The agent-function section is provided so as to interpret the XML description format (for example, JDF) expressed in a print instruction and carry out conversion processing between the above description format and dedicated language that is used to activate a mechanical unit or processing unit of each of the devices that constitute the print processing system 1.

FIG. 3 is a block diagram for illustrating the mutual relationship between the various devices that constitute the print processing system 1. Each device stores therein interface information that represents contents of a service provided by itself, and has an agent-function section that interprets contents of description given in the print instruction. In the following descriptions, unless explicitly stated otherwise, the agent-function section is structured so as to interpret the description contents given in the print instruction that is expressed by a first description format, such as JDF.

Namely, the devices illustrated in FIG. 3 are explicitly shown, which devices each has the agent-function section based on each of the various devices shown in FIG. 1. The client terminal 10 is allowed to selectively use either print instruction described by the first description format such as JDF and the second description format (for example, a description format of XML other than JDF). Further, the DTP device 11 can perform processing based on the print instruction described by the first description format such as JDF, and has an input editing function and forms a photographic printing paper or a process film by using print data obtained by processing a page layout on a computer. Therefore, the DTP device 11 comprises an agent-function section 11X and a DTP-function section 11A. Incidentally, the DTP device 11 may be made to function only processing for forming a photographic printing paper or a process film based on print data of a page layout prepared at the client terminal 10.

In the devices shown in FIG. 3, the DFE device 20, the CTP device 50, the printer 52, the finisher device 54, the delivery management device 56, and the DDCP device 58 are each provided as a device that enables processing based on the print instruction described with the first description format (JDF). Further, the MIS device 30 is used to administrate print instructions described in the description format of JDF. The coordinate server 40 is used to administrate the print instructions described in the second description format (for example, XML expression having a description format other than JDF).

In FIG. 3, the image forming device 62 and the image forming device 68 differ from each other in the structures thereof. That is, the image forming device 62 is directly connected to the network 2, and the image forming device 68 is under the control of the BEP device 60. In the present embodiment, the image forming device 62 is used to realize processing based on the print instruction described by the second description format (for example, XML expression having a description format other than JDF). For this reason, the image forming device 62 is constituted from a job flow engine 62Z for interpreting the print instruction having the second description format, and a printer 62A. That is, the job flow engine 62Z is provided so as to interpret the print instruction having the second description format, convert print data into a language inherent in the printer 62A, and further, output the data to the printer 62A.

The BEP device 60 is structured so as to be capable of performing both processing based on the print instruction described by the first description format (for example, JDF) and processing based on the print instruction described by the second description format (for example, XML expression having a description format other than JDF) by means of the devices under the control of the BEP device 60. To this end, the BEP device 60 has an agent-function section 60X for interpreting both of the aforementioned description formats. Further, the BEP device 60 can have the function of converting the description format therebetween. The agent-function section 60X includes a selection section 60Y for selecting, as a destination to which it is connected, an output destination to a device that can perform processing by the print instruction having the first description format or to a device that can perform processing by the print instruction having the second description format. The DDCP device 64 is connected to the selecting section 60Y and the image forming device 68 is connected to the selecting section 60Y via a job flow engine 60Z for interpreting the print instruction having the second description format.

FIGS. 4A to 4D show the structure of a print instruction, and the flow of data addition. As shown in FIG. 4A, the print instructions comprise various basic fields, that is, <printed-matter specifications>, <plate-making process>, <printing process>, <folding process>, <cutting process>, <binding process>, and <delivery process>”. These print instructions are described by a predetermined description format (for example, JDF, or XML expression having a description format other than JDF).

The <printed-matter specifications> indicate each specification items of a printed matter, which is an outputted result of the print processing system 1. Predefined items are used in the <printed-matter specifications>, and are inputted and set mainly in, for example, the print order and sales department of a printing company, i.e., places that receive and fill user or customer requests for printed matters. For example, the composition, paper quality, size, and number of copies correspond to the items. The <plate-making process> is an item that defines a process for preparing a printing plate for printing, and is inputted and set mainly in a place such as a process management department in which a plate-making processing is managed. For example, information regarding equipment used for making a plate, a process delivery date, and the like correspond to the items. The <printing process> is an item that substantially defines a printing process, and is input and set mainly in places such as process management departments in which printing processing is managed. Information such as the equipment used for printing and the ink used correspond to the items.

The <folding process> is an item that defines a folding process for a printed output, and is inputted and set mainly in, for example, the process management department of a or the like in which a folding process is managed. For example, equipment used for the folding processing, a process delivery date, and the like correspond to the items. The <cutting process> is an item that defines a cutting process for a printed output or an output subjected to the folding processing, and is inputted and set mainly in a place such as a process management department in which the cutting process is managed. Examples of information that correspond to the items include the equipment used for the cutting processing and a process delivery date. The <binding process> is an item that defines a binding process for any one of a printed output, an output subjected to the folding processing, and an output subjected to the cutting processing. The <binding process> is inputted and set mainly in places where the binding process is managed, such as the print process management department. For example, equipment used for the binding processing, a process delivery date, and the like correspond to the items.

In the print instruction 70 shown in FIG. 4A having no specific description, the <printed-matter specifications> and <delivery process> are determined, by receiving an order for printed matter from a requesting party (i.e., customer), as shown in FIG. 4B, and the determined items are described in the print instruction 70. This processing is performed mainly by an input operation at the client terminal 10. In this case, no specific item of the printing process in the print instruction 70 has been determined, and therefore, the print instruction 70 is distributed to each of the processes. As shown in FIG. 4C, data of each of the fields constituted from the <plate-making process>, <printing process>, <folding process>, <cutting process>, and <binding process> is determined, and the determined items are described in the print instruction 70. This processing is carried out by the device to be used for each process, and it is basically not affected by other devices (processes). That is, it suffices that the determined items of each process shown in FIG. 4C are data that corresponds to specification items to be processed in its own process, and detailed data in the process is not required. However, determination of detailed specification is required for actual processing data in each process, and as shown in FIG. 4D, in each of the processes, the detailed specification items in performing processing in its own process are determined and the process is performed.

(Print Coordination Processing)

Coordination processing for obtaining a printed matter is carried out by a user reading out a print instruction. Specifically, this processing is carried out as described below.

In the present embodiment, a control device to be used varies depending on the description format of a print instruction. In the following description, by way of example, the MIS device 30 is responsible for the print instruction having a JDF description format (hereinafter referred to as “JDF”), that is, a first description format of the print instruction; and the coordinate server 40 is responsible for the print instruction having an XML format description other than the JDF format (hereinafter referred to as “other description format”), that is, a second description format. However, the MIS device 30 has a management function of managing the whole print processing system 1, and also has the function of enabling preparation of a print instruction described in a description format other than JDF or the like (for example, other formats such as XML description format other than JDF).

Further, the client terminal 10 serves the function of a graphical user interface (GUI) for carrying out displaying on a screen or predetermined operations so as to give an instruction to prepare a print instruction and select a print instruction to start.

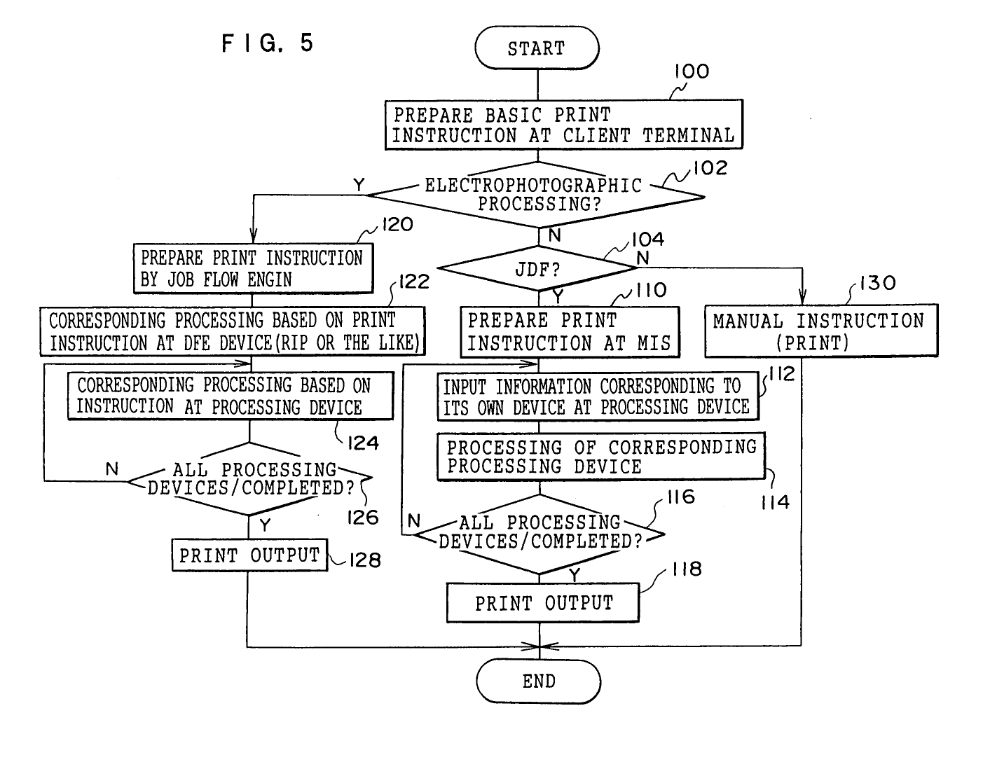

FIG. 5 shows a process flow chart concerning the coordinate processing starting from a request for a printed matter to acquisition of the printed matter.

First, the client terminal 10 stores therein a print instruction composed of each blank field (see FIG. 4A), and the stored basic print instruction is read (step 100). At the client terminal 10, the read basic print instruction 70 is displayed, and a basic print instruction 70 that indicates a request for a printed matter is prepared by a user entering initial necessary information in a basic print instruction, and the prepared print instruction is outputted externally.

In this case, as the description format of the print instruction 70, any one of a print instruction in JDF, a print instruction having other description formats, and a print instruction for manual preparation is selected and instructed. At this time, in order to make a user operating the client terminal 10 to skip selection of a print instruction, any one of the aforementioned print instructions may also be set as an initial value.

It is noted that the print instruction is not limited to being stored in the client terminal 10. For example, the print instruction may be stored in advance and read from the MIS device 30. Further, with an accumulation server which stores print instructions and is connected to the network 2, the print instruction may be read out from the accumulation server. Still further, a different device connected to the network 2, having the function of the accumulation server, may be made to output a print instruction as required. Alternatively, with multiple print instructions being distributed or shared with other devices connected to the network 2, a print service related to printing requested by a user may be searched from any one of the multiple devices connected to the network 2.

Subsequently, as the print instruction 70, any one of the print instructions having JDF or other description format, or the print instructions for manual instruction is selected and instructed. Therefore, the necessary processes for acquiring specific printed matter vary depending on the content of the request or order. That is, any one of the aforementioned three types of print instructions is determined (steps 102 and 104). If the print instruction having other description format is selected (if the determination of step 102 is affirmative), the print instruction is prepared in the coordinate server 40 (step 120). If the JDF print instruction is selected (if the determination of step 102 is negative and the determination of step 104 is affirmative), the print instruction is prepared in the MIS device 30 (step 110). Further, if the print instruction for manual instruction is selected (if the determinations of step 102 and step 104 are both negative), the print instruction is printed (step 130).

In the print processing system 1 of the present embodiment, the processing device for processing a print service executes the process described below correspondingly to the format of the print instruction.

JDF Print Instruction

First, the process corresponding to JDF print instruction will be described. When the basic print instruction is in JDF, the print instruction is prepared in the MIS device 30 (step 110).

JDF print instruction does not necessarily have a description of all information concerning control of coordination processing of services related to printing. The JDF print instruction may have a description of the basic fields that are processes concerning printing (hereinafter referred to as “printing-related processes”), and items in the fields may be sequentially filled with devices that carry out each service. In order to realize the coordination processing, the MIS device 30 can produce the basic print instruction (see FIG. 4A) that is used to coordinate the printing-related processes (and the services executed therein). That is, the MIS device 30 recognizes and manages the processing device for processing the printing-related processes distributed on the network 2 by acquiring or searching in advance for location information indicating the (node) position, on the network 2, of a device responsible for or managing a printing-related process (service). Next, the MIS device 30 prepares, for the aforementioned basic print instruction, an HTML file that becomes a GUI screen on which a user's request is reflected, and as required from the client terminal 10, the MIS device 30 transmits it to the client terminal 10.

The client terminal 10 transmits to the MIS device 30 an HTML file containing items in the field defined by a user's operation. The MIS device 30 receives the HTML file and prepares a print instruction on which at least a user's request is reflected (see FIG. 4B). The print instruction is a JDF file.

Further, the MIS device 30 can interpret and execute a print instruction, and manage the related devices. The MIS device 30 interprets a basic print instruction received from the client terminal 10, outputs the instruction to each processing device in accordance with the printing-related processes described in the print instruction, and executes printing coordination processing. Further, the MIS device 30 can store information about the state of coordination processing in active operation, or the result of the completed processing, and notify the state or result of the coordination processing as required from outside.

When the MIS device 30 interprets the print instruction and makes a request to the processing devices responsible for the printing-related processes, it is not necessary to prepare individual instruction information having contents of a processing request or input parameters, or information for specifying a document to be processed, as such information is processed within the printing-related processes. That is, unless there are special instructions from the user, the request made by the MIS device 30 to the processing devices is simply a notification indicating that there is a request for each printing-related process. Further, the processing devices responsible for each of the printing-related processes notifies the MIS device 30 of information concerning specifications required for obtaining the printed matter, such as equipment available and the delivery due date, as a response to the request. Based on the information, the MIS device 30 can fill the fields of the print instruction 70.

Specific processes will be described hereinafter.

Each processing device respectively responsible for the printing-related processes notifies, at the start-up processing, the MIS device 30 of interface information including information that indicates the outline of the printing-related process and address. Further, each processing device responsible for a corresponding printing-related process sets up various specifications for managing the details of each printing-related process. The MIS device 30 stores therein interface information transmitted from each processing device responsible for the printing-related process.

First, the client terminal 10 accesses, through an installed browser, a uniform resource locator (URL) such as an HTML file prepared for a user interface screen provided inside of itself or provided by another server in accordance with a user's operation. The HTML file of the user interface screen (that is, a basic print instruction) is transferred to the client terminal 10 in response to a request for reading from an access destination, and a screen is displayed at the client terminal 10. At this time, the user can define the specifications for acquiring a desired printed matter using the user interface screen displayed at the client terminal 10. That is, the user enters or inputs items such as the specifications of the requested printed matter.

When the specifications of the printed matter have been defined via the user interface screen, the client terminal 10 transmits to the MIS device 30 a print instruction including the specifications of the printed matter defined by the user (that is, an HTML file including items in the fields defined by the operation of the user).

The MIS device 30 prepares a print instruction in which information for specifying each printing-related process is defined, on the basis of a print instruction including the specifications of the printed matter transmitted from the client terminal 10 (that is, an HTML file), and interface information acquired from each of the processing devices (step 110). As a result, the MIS device 30 acquires the JDF formatted print instruction.

Next, the MIS device 30 starts executing the coordination processing corresponding to the print instruction given from the client terminal 10 (steps 112 to 118). First, the MIS device 30 interprets the print instruction from the client terminal 10, and notifies one of the printing-related processes described in the print instruction of that an instruction for processing a printing-related process has been given to a processing device responsible for a corresponding printing-related process. To that end, the processing device responsible for the printing-related process inputs information concerning the specifications required for acquiring the printed matter, such as equipment that is available in its own process, or a delivery date, and notifies the MIS device 30 (step 112). At the same time, the processing device generates specific individual instruction information having contents of a processing request or input parameters, information for specifying a document to be processed, and the like. In the processing device, processing of a requested printing-related process is performed (step 114). The MIS device 30 performs the aforementioned processing repeatedly until all of the instructions for the printing-related processes described in the print instruction have been completed (step 116). The printing-related processes mentioned herein correspond to each processing in the DFE device 20, CTP device 50, printer 52, finisher device 54, delivery management device 56, DDCP device 58 and the like.

When all processing has been completed (if the determination of step 116 is affirmative), the processing based on the print instruction is considered completed, whereby corresponding post-processing is performed (step 118). The post-processing mentioned herein refers to processing in which a printed matter prepared in the printer 52 is made into a final product by the finisher device 54, and then distributed by the delivery management device 56.

It should be noted that after inquiries are made regarding only completion of the print instruction and only response processing is performed (steps 112 to 116), the post-processing may be performed for a print output in accordance with the print instruction generated from the aforementioned steps (step 118).

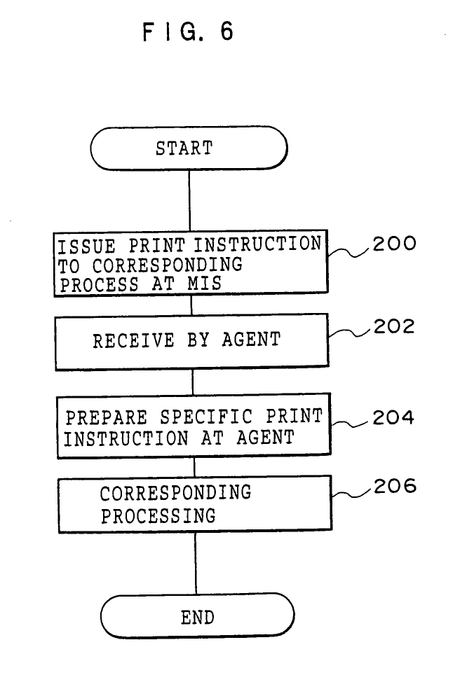

Next, a description will be given of processing to be performed by a processing device responsible for one of printing-related processes described in the print instruction from the client terminal 10, which is interpreted by the MIS device 30, that is, processing to be performed by a processing device at steps 112 and 114. FIG. 6 shows a process flow chart concerning processing to be performed by a processing device responsible for one printing-related process. In the following description, <printing process> is shown as an example of a printing-related process, and the printer 52 is used as an example of the processing device responsible for the printing-related process.

First, the MIS device 30 interprets the print instruction, and makes a request for the <printing process> described in the print instruction to execute a corresponding service (print processing)(step 200). In this case, the JDF print instruction is issued to the printer 52, and received by an agent 52X of the printer 52 (step 202). The agent 52X interprets the received JDF print instruction, and extracts the relevant portion corresponding to its own process. The agent 52X displays a user interface screen so as to make a user managing the <printing process> to input information concerning the specifications required for obtaining a printed matter, such as equipment available in the <printing process>, and a delivery date by displaying an instruction from the MIS device 30. As a result, the user managing the <printing process> enters items such as the specifications of the <printing process> required by the user. The entered items are notified to the MIS device 30. The state in which items such as the specifications of <printing process> are inputted is shown in FIG. 4C.

In connection with the aforementioned processing, the agent 52X generates specific individual instruction information having contents of a processing request or input parameters, information for specifying a document to be processed, and the like (step 204). As a result, processing in the <printing process> becomes practicable. An individual print instruction in which items of specific individual instruction information in the <printing process> (in FIG. 4C, items of device setting and ink setting) are inputted as shown in FIG. 4D. As the processing corresponding to the <printing process>, a printer is activated based on an individual print instruction shown in FIG. 4D, and printing is performed (step 206).

Print Instruction Having Other Description Format

Next, a description will be given of a process corresponding to a print instruction having other description format. Japanese Patent Application No. 2002-275230, which was filed by the same applicant of the present invention, relates to coordination processing using a print instruction having other description format. First, when the basic print instruction is a print instruction of XML having other description format, a print instruction is prepared in the coordinate server 40 (step 120 in FIG. 5).

The print instruction of other description format includes a description of all information relating to control of coordination processing of services concerning printing. In order to realize this coordination processing, the coordinate server 40 can search for services concerning print processing and prepare a print instruction for allowing coordination of these services. That is, the coordinate server 40 acquires, in advance, location information that represents the position of nodes on the network 2 that executes services concerning print processing. Based on the location information, the coordinate server 40 acquires interface information representing an input/output relationship of each processing device or an application program, from processing devices, which are distributed on the network 2 and execute services concerning print processing, and manages the interface information. Based on the acquired interface information, the coordinate server 40 prepares an HTML file that becomes a GUI screen for defining a job flow (how to perform coordination of services), and transmits it to the client terminal 10 in accordance with the request by the client terminal 10.

The client terminal 10 transmits the job flow information defined by a user's operation to the coordinate server 40 by the Common Gateway Interface (CGI) format. The coordinate server 40 prepares, based on the job flow information concerning a user's instruction for service coordination, and interface information of each service, a print instruction including defined information, such as contents of processing required for each service, input parameters, how to perform coordination of services (job flow), and information for specifying a document to be processed such as a document name or a storage location information. The print instruction is constituted by a file of other description format.

Further, the coordinate server 40 can interpret and execute the print instruction. The coordinate server 40 executes coordination processing in such a manner as to interpret the print instruction received from the client terminal 10, and sequentially invoking the service processing devices of each of the processing devices (in the present embodiment, the image forming device 62 and the like) in accordance with the sequential order and the way of use described on the print instruction. Moreover, the coordinate server 40 can store therein information about the status of the active coordination processing, or the result of the completed coordination processing, and can notify the status or result of the coordination processing upon request therefor from outside.

When the coordinate server 40 interprets the print instruction and gives a request to each service processing device, the coordinate server 40 generates individual instruction information having contents of a request for processing, input parameters, information for specifying a document to be processed or the like. Incidentally, the coordinate server 40 may be provided so as to describe on the print instruction the relationship between preceding processing and subsequent processing to be performed in each service processing device, or may be provided so as to make a request for processing in the form of information exchange inherent in each processing device, or each application program that executes a service, instead of in the form of the print instruction.

The image forming device 62 that is an example of a device that performs a print service processes a document, that is, printing based on information contained in a request for processing from the coordinate server 40 such as contents of a request for service processing, input parameters, and information of a document to be processed. The image forming device 62 notifies, at the time of starting, the coordinate server 40 of interface information of its own device. The interface information is used at the time of preparing the print instruction.

A specific process will be hereinafter described.

The service processing device such as the image forming device 62 notifies, at the time of starting processing, the coordinate server 40 of interface information including information that indicates an outline of each service, and an address thereof. The coordinate server 40 stores therein interface information transmitted from each service processing device such as the image forming device 62.

First, the client terminal 10 provides access to a URL of an HTML file generated for a user interface screen provided from internally or by a different server via an installed browser in accordance with a user's operation. In accordance with a request, the HTML file for the user interface screen is transmitted to the client terminal 10 from the access destination, and the client terminal 10 provides screen displaying. At this time, the user can define the flow of desired print processing coordination (hereinafter referred to as “print coordination flow”) by using the user interface screen displayed at the client terminal 10.

When the print coordination flow is defined via the user interface screen, the client terminal 10 transmits the print coordination flow information concerning the print coordination defined by the user to the coordinate server 40.

The coordinate server 40 prepares, based on information concerning the print coordination flow transmitted from the client terminal 10, and interface information acquired from each processing device, a print instruction in which information such as contents of processing required for each service, input parameters, how to perform coordination of services, and information for specifying a document to be processed such as a document name, storage location information, and the like is defined (step 120). As a result, the coordinate server 40 obtains a print instruction of other description format.

Subsequently, the coordinate server 40 starts executing coordination processing corresponding to the print instruction requested by the client terminal 10 (steps 122 to 128).

The coordinate server 40 interprets the print instruction, and makes a request for executing corresponding service processing to the first processing described in the print instruction (step 122). The service processing mentioned herein corresponds to RIP processing in which a raster image for printing is generated. The coordinate server 40 prepares individual instruction information for DFE device 20 and transmits the prepared information to the DFE device 20. The DFE device 20 executes the RIP processing for generating a raster image. When this processing is completed, the DFE device 20 transmits to the coordinate server 40 processing results such as status information of processing (completion), an output parameter, information about a document storage destination after the processing (location information of its own device or other device), and the like.

Subsequently, the coordinate server 40 interprets the print instruction, and makes a request for execution of service processing corresponding to a subsequent processing described on the print instruction (step 124). In this case, the service processing to be executed corresponds to print processing for preparing a print in the image forming device 62. The coordinate server 40 prepares individual instruction information for the image forming device 62, and transmits the information to the image forming device 62. The image forming device 62 executes print processing. When this processing is completed, the image forming device 62 transmits to the coordinate server 40 processing results such as status information of processing (completion), an output parameter, information about a document storage destination after the processing (location information of its own device or other device), and the like.

Thereafter, the coordinate server 40 interprets the print instruction, and makes a determination as to whether subsequent processing described on the print instruction exists or not. If an unprocessed service exists (if the determination of step 126 is negative), the aforementioned processing is repeated. On the other hand, when all processing is completed (if the determination of step 126 is affirmative), and it is considered that processing based on the print instruction has been completed, corresponding post-processing is executed (step 128). A distribution of prints prepared in the image forming device 62, or sorting of prints or the like correspond to the aforementioned post-processing.

The coordinate server 40 can manage, as a log, results of processing in the image forming device 62 or the like, or result of a request for processing.

Print Instruction in the Form of Manual Instruction

Next, a process corresponding to a print instruction in the form of manual instruction will be described. In this case, the print instruction is not dependent on the aforementioned form, and the printing-related processing is performed by a user giving a notice in an individual communication mode or others. That is, the print instruction in the form of manual instruction is prepared at the client terminal 10 (step 130).

It should be noted that the print instruction in the form of manual instruction needs to include a description of all information concerning control of coordination processing of services related to printing. Accordingly, in order that the print instruction may include a description of all information concerning control of coordination processing of services related to printing, the client terminal 10 provides in advance a template in which all information can be entered, which enables preparation of the print instruction data by filling in the template, and then prints this data. Due to a user giving a manual instruction using the prepared print, coordination processing of services related to printing is realized by a manual operation.

[Merging Workflows for Printing and Electrophotography]

With reference to the flow chart shown in FIG. 5, print processing executed based on a first print instruction in JDF format or a second print instruction having other description format using a conventional printing plate or printing processing using an electrophotographic system is described above. Further, in the above example, progress management of the whole print processing based on the first print instruction was performed by the MIS device 30 and progress management of the whole print processing based on the second print instruction was performed by the coordinate server 40.

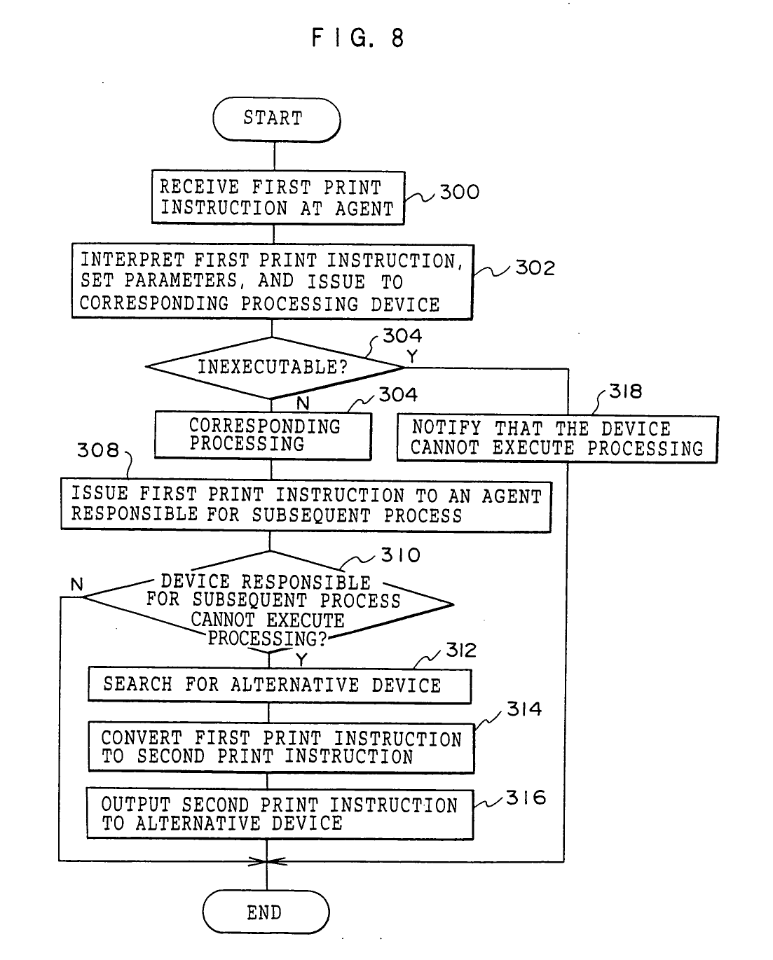

Next, with reference to the flow chart shown in FIG. 8, there will be described a case in which the MIS device 30 or the coordinate server 40 does not manage the progress of the whole print processing, and a device for executing a corresponding process performs management of a subsequent process, and when the device is not capable of executing the subsequent process, a device that is capable of executing the substantially same processing as the subsequent process and that is capable of performing processing based on the second print instruction is substituted. The controlling shown in FIG. 8 is executed by a device that is capable of executing processing based on the first print instruction.

When the first print instruction is outputted from an agent of a processing device responsible for a previous process to a processing device responsible for a subsequent process, the first print instruction is received by an agent responsible for the subsequent process (step 300). For example, when processing for color proofing is carried out, the first print instruction is received by an agent 58X.

Then, the agent interprets the received first print instruction, and describes, in the first print instruction, a parameter to be set in a processing device responsible for its own process, and outputs the print instruction to the processing device (step 302). For example, when the processing for color proofing is carried out, the first print instruction is outputted by the agent 58X to the proofer 58A. Further, as the aforementioned parameter, for example, a parameter previously set and stored in internal memory may be read out and used, or a parameter set by the operation of a user may be used.

Subsequently, the agent makes a determination as to whether the processing device that outputted the first print instruction is in the state of being not capable of executing processing (step 304). Specifically, the state of the processing device can be acquired by, for example, transmitting a command for inquiry about the state of the processing device and receiving a return command from the processing device. As the state of the processing device, an executable state in which the processing device does not particularly execute a job and is in the state of being capable of executing processing, a busy state in which the processing device is in execution of a job and is not capable of executing processing, and an non-executable state in which the processing device is not capable of executing processing due to failure or power off are provided. Incidentally, when no reply is received even if the command for inquiry about the state is transmitted to the DDCP 58, it can be determined that the device is in a non-executable state.

When the processing device is in the state of being capable of executing processing, corresponding processing is executed by the processing device (step 306). At this time, the notification that the processing has been normally executed and completed may be given to the agent of a previous process.

However, when the processing device is in a busy state or in a non-executable state, the agent notifies the agent of the previous process, of the non-executable state of the processing device (step 318). As a result, the agent of the previous process searches for a device that can execute processing alternatively, and makes the alternative device to execute processing (described below).

When the processing device has completed its own processing, the agent issues the first print instruction to an agent of a subsequent process defined in the first print instruction. In the agent of the subsequent process, the control routine shown in FIG. 8 is executed in the same manner as described above. Then, a determination is made as to whether a processing device responsible for the subsequent process is in a non-executable state (step 310). If the processing device responsible for the subsequent process is not in the non-executable state, this routine ends. If the processing device responsible for the subsequent process is in the non-executable state, an alternative device that can execute processing based on the second print instruction and that can alternatively perform the substantially same processing as that of processes subsequent to the present process is searched (step 312). Specifically, it is possible to broadcast an inquiry signal as to whether alternative processing is possible or not and specify, as an alternative device, a device that makes a reply that it is capable of executing processing. It should be noted that information on a device that is capable of executing processing substantially same as that of processes subsequent to its own process may be stored in advance and used for specifying an alternative device.

The first print instruction is converted to the second print instruction (step 314). As a result, the parameters set in the first print instruction are converted to parameters for a processing device that is capable of executing processing based on the second print instruction. The parameters includes, for example, page sequence, selection of double-sided print/single-sided print, selection of an output tray, paper size, selection of color print/black-and-white print, and the like.

The converted second print instruction is outputted to a searched alternative device (step 316). As a result, the alternative device interprets the received second print instruction and alternatively processes the substantially same processing as that which cannot be processed based on the first print instruction.

Due to the subsequent process being managed by each agent as described, the MIS device 30 does not need to manage the whole print processing. Further, even when the processing based on the first print instruction is made non-executable in the middle of the processing, an alternative device that is capable of executing processing based on the second print processing can be used alternatively. Therefore, the print processing can be executed without any delay in the delivery date.

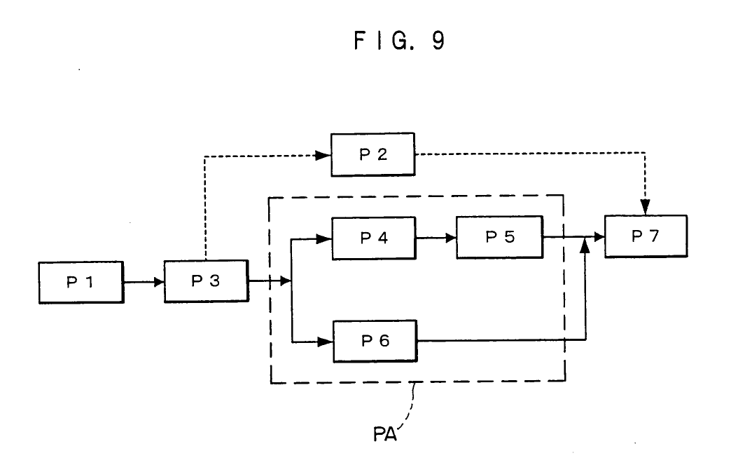

FIG. 9 shows a specific example of a process flow defined by the first print instruction. In the example shown in FIG. 9, normally, these processes are executed in order of P1, P3, PA, and P7. The process PA is constituted from process P4, process P5, and process P6. Process P5 is executed after the process P4, and the process P6 can be executed in parallel with the process P4 and the process P5. Process P1, process P3, process P4, process P5, and process P6 are processes executed by a device that is capable of processing based on the first print instruction. Process P2 is a process executed by a device that is capable of processing based on the second print instruction.

The first print instruction defines the process flow based on the first print instruction shown in FIG. 9, that is, the process P1, process P3, process PA, and process P7, which are executed in this order. It also defines that in the process PA, the process P4 is first executed, and the process P5 is subsequently executed, and the process P6 can be executed in parallel with the process P4 and process P5.

In a case in which the process flow as described above is defined, first, when the process P1 ends, the agent responsible for the process P1 outputs the first print instruction to an agent responsible for the process P3. The agent responsible for the process P3 interprets the first print instruction, and executes corresponding processing, and then, outputs the first print instruction to an agent responsible for the process P4 and the process P6 that are the subsequent processes and that can be executed in parallel with each other.

Each agent responsible for the process P4, process P5, and process P6 also execute the same processing as described above. While an agent responsible for the process P7 receives outputs of the first print instruction from the agent responsible for the process P5 and from the agent responsible for the process P6, the agent responsible for the process P7 may execute its own processing if it receives both of these outputs so that it can determine that the process PA has been completed. That is, in a case in which the agent responsible for the process P7 recognizes that the previous processes are the process P5 and the process P6 in step 302 of FIG. 8, if it receives the first print instruction from both the agents responsible for the process P5 and the process P6, subsequent processing may be carried out.

For example, when processing is not capable of being executed in the process P4 or the process P6 due to a busy state or the like (if the determination of step 310 shown in FIG. 8 is affirmative), the agent responsible for the process P3 searches for an alternative device that can execute the same processing as that of the process P3 and the process PA. In a case in which the device that can execute the process P2 to be processed based on the second print instruction, which process P2 is the substantially same processing as that of the process P3 and the process PA, makes a reply that it can execute processing as an alternative device, the agent responsible for the process P3 converts the first print instruction to a second print instruction for executing the substantially same processing based on the first print instruction, and outputs the converted print instruction to the job flow engine responsible for the process P2.

For example, in a case in which the process P1 is an imposition and RIP process, the process P3 is the CTP process, the process P4 is a printer process, the process P5 is the process of a folding machine and a cutting machine, and the process P7 is the process of a binding machine, if the process P4 cannot be executed, the agent 50X of the CTP device 50 responsible for the process P3 converts the first print instruction to the second print instruction, and outputs it to the job flow engine 62Z of the image forming device 62.

As a result, even when the processing based on the first print instruction cannot be executed in the middle of or during the process, the alternative processing is carried out by the device responsible for the process P2 that can execute processing based on the second print instruction. Therefore, the print processing can be executed without any delay in the delivery date.

In the foregoing, the processing for converting the first print instruction to the second print instruction is carried out by the device responsible for the process P3, that is, the device that executes processing based on the first print instruction. However, this conversion processing may also be carried out by the device responsible for the process P2, that is, the device that carries out the processing based on the second print instruction.

Further, in the present embodiment, when a device responsible for a subsequent process cannot execute the processing based on the first print instruction, the second print instruction is outputted to a device that executes processing based on the second print instruction and that can execute similar processing. However, the present invention can also be applied to a case in which the printing process in which print processing based on the second print instruction is performed when the device responsible for a subsequent process cannot execute processing based on the second print instruction, the first print instruction is outputted to a device that executes processing based on the first print instruction and that can execute similar processing.

Further, the present invention not limited to generating different print instructions or converting print instructions to different formats. That is, a processing device that can interpret the first print instruction and that can execute the same processing as that of the device for processing the first print instruction in a subsequent process may also be used as an alternative processing device.

Further, the alternative processing device to be set may be selected not only from multiple devices that are exactly the same, but also from devices that have the same functions, despite being different types of machines, or manufactured by different manufacturers, or different from one another in the print instruction description format. When differing devices are used, the processing time or processing accuracy (processing quality such as print quality) varies depending on a device set. For this reason, it is possible to positively perform setting of an alternative processing device. That is, in the foregoing, a processing device is switched when a state in which a device responsible for a subsequent process is capable of operating is detected. However, it is also possible to detect the operating state of the device responsible for a subsequent process and substitute a processing device of which processing time or processing accuracy coincides with that which is previously set or inputted. As a result, when a user makes a request for rush printing, a printed matter that corresponds to a user's request can be provided by setting the quickest processing device in the print processing system 1 as an alternative processing device and then carrying out print processing using the same.

As described above, the present invention provides a print processing device which processes at least a portion of a printing process in a printing system for processing a print job based on a print instruction in which request items in a printing process for obtaining a printed matter are described in a predetermined description format, the print processing device including: a determination section which, based on the print instruction acquired from a previous process, determines whether a first processing device that is to perform a subsequent process is capable of executing processing; and an output section which, when the first processing device that is to process a subsequent process is capable of executing processing, outputs the print instruction to the first processing device that is to process a subsequent process, and when the first processing device is not capable of executing processing, the output section outputs, to a second processing device that can be substituted for the first processing device, a print instruction corresponding to the substituted second processing device.

The output section can be structured so as to include a search section that, when a first processing device that is to execute a subsequent process cannot execute processing, searches for a second processing device that can execute the substantially same processing as that subsequent to the predetermined process and that interprets the second print instruction and executes the predetermined process.

The search section may broadcast an inquiry signal as to whether, for example, the substantially same processing as that subsequent to its own process can be executed or not, and based on the response, search for a device that executes the subsequent process alternatively.

Further, an alternative device that can be substituted so as to execute processing subsequent to its own process may be stored in advance in each device so that when the subsequent process cannot be executed, the second print instruction may also be outputted to a stored alternative device without having to search for a device substituted to execute processing.

Still further, the output section can be structured so as to include a conversion section that, when the first processing device that is to execute the subsequent process cannot execute processing, converts the first print instruction to the second print instruction.

That is, the conversion section generates the second print instruction for executing the substantially same processing as that based on the first print instruction, and outputs the second print instruction to a device substituted for executing processing.

1. A print processing device which processes at least a portion of a printing process in a printing system for processing a print job based on a print instruction in which request items in a printing process for obtaining a printed matter are described in a predetermined description format, the print processing device comprising:
a determination section that, based on the print instruction acquired from a previous process, determines whether a first processing device that is to perform a subsequent process is capable of executing processing; and
an output section that, when the first processing device that is to process a subsequent process is capable of executing processing, outputs the print instruction to the first processing device that is to process a subsequent process, and when the first processing device is not capable of executing processing, outputs, to a second processing device that can be substituted for the first processing device, a print instruction corresponding to the substitute second processing device.

2. The print processing device according to claim 1, further comprising a notification section that determines whether the processing based on the print instruction acquired from a previous process can be executed by its own process, and when it is determined that the process cannot be executed, notifying a processing device having executed the previous process that the processing cannot be executed.

3. The print processing device according to claim 2, wherein, when processing based on the print instruction acquired from a previous process has been normally completed in its own process, the notification section notifies the processing device having executed the previous process that the processing has been normally completed.

4. A print processing device which processes at least a portion of a printing process in a printing system for processing a print job based on a first print instruction in which request items in a printing process for obtaining a printed matter are described in a first description format, or on a second print instruction in which request items are described in a second description format that differs from the first description format, the print processing device comprising:
an interpretation section that interprets the first print instruction acquired from a previous process;
a determination section that outputs the first print instruction to a first processing device responsible for a predetermined process, and after completion of processing by the first processing device, determines whether a first processing device that is to perform a subsequent process is capable of executing processing; and
an output section that, when the first processing device that is to perform a subsequent process is capable of executing processing, outputs the first print instruction to the first processing device that is to perform a subsequent process, and when the first processing device that is to perform a subsequent process is not capable of executing processing, outputs the second print instruction to a second processing device that is capable of executing processing that is at least substantially the same as subsequent processing and that interprets the second print instruction and executes a predetermined process.

5. The print processing device according to claim 4, further comprising a notification section that determines whether the processing based on the first print instruction acquired from a previous process can be executed by its own process, and when it is determined that the process cannot be executed, notifies a processing device having executed the previous process that the processing cannot be executed.

6. The print processing device according to claim 5, wherein, when processing based on the first print instruction acquired from a previous process has been normally completed in its own process, the notification section notifies the processing device having executed a subsequent process that the processing has been normally completed.

7. The print processing device according to claim 4, wherein the output section comprises a search section that, when the first processing device that is to perform a subsequent process is not capable of executing processing, searches for a second processing device that is capable of executing processing that is at least substantially the same as subsequent processing and interprets the second print instruction and executes a predetermined process.

8. The print processing device according to claim 4, wherein the output section comprises a conversion section that converts the first print instruction to the second print instruction when the first processing device that is to perform a subsequent process is not capable of executing processing.

9. A print processing method which processes at least a portion of a printing process in a printing system for processing a print job based on a print instruction in which request items in a printing process for obtaining a printed matter are described in a predetermined description format, the print processing method comprising:
determining whether a first processing device that is to perform a subsequent process is capable of executing processing based on the print instruction acquired from a previous process; and
outputting the print instruction to the first processing device that is to perform a subsequent process when the first processing device is capable of executing processing, and when the first processing device is not capable of executing processing, outputting, to a second processing device that can be substituted for the first processing device, a print instruction having a description format corresponding to the substitute second processing device.

10. The print processing method according to claim 9, further comprising determining whether processing based on the print instruction acquired from a previous process can be executed by its own process, and when it is determined that the process cannot be executed, notifying a processing device having executed the previous process that the processing cannot be executed.

11. The print processing method according to claim 10, wherein the notifying comprises, when processing based on the print instruction acquired from a previous process has been normally completed in its own process, notifying the processing device having executed the previous process that the processing has been normally completed.

12. A print processing method which processes at least a portion of a printing process in a printing system for processing a print job based on a first print instruction in which request items in a printing process for obtaining a printed matter are described in a first description format, or on a second print instruction in which the request items are described in a second description format that differs from the first description format, the print processing method comprising:
interpreting the first print instruction acquired from a previous process;
outputting the first print instruction to a first processing device responsible for a predetermined process, and after completion of processing by the first processing device, determining whether a first processing device that is to perform a subsequent process is capable of executing processing; and
when the first processing device that is to perform the subsequent process is capable of executing processing, outputting the first print instruction to the first processing device that is to perform the subsequent process, and when the first processing device that is to perform the subsequent process is not capable of executing processing, outputting the second print instruction to a second processing device that is capable of executing processing that is at least substantially the same as subsequent processing and that interprets the second print instruction and executes a predetermined process.

13. The print processing method according to claim 12, further comprising determining whether the processing based on the print instruction acquired from a previous process can be executed by its own process, and when it is determined that the process cannot be executed, notifying a processing device having executed the previous process that the processing cannot be executed.

14. The print processing method according to claim 13, wherein the notifying comprises, when processing based on the print instruction acquired from a previous process has been normally completed in its own process, notifying the processing device having executed the previous process that the processing has been normally completed.

15. The print processing method according to claim 12, wherein the outputting comprises searching for a second processing device that, when the first processing device that is to perform a subsequent process is not capable of executing processing, is capable of executing processing that is at least substantially the same as subsequent processing and that interprets the second print instruction and executes a predetermined process.

16. The print processing method according to claim 12, wherein the outputting comprises converting the first print instruction to the second print instruction when the first processing device that is to perform a subsequent process is not capable of executing processing.

17. A computer-readable storage medium storing a print processing program executable by a computer to process at least a portion of the printing process in a printing system for processing a print job based on a print instruction in which request items in a printing process for obtaining a printed matter are described in a predetermined description format, the processing comprising:
determining whether a first processing device that is to perform a subsequent process is capable of executing processing based on the print instruction acquired from a previous process; and
outputting the print instruction to the first processing device when the first processing device is capable of executing, and when the first processing device is not capable of executing, outputting to a second processing device that can be substituted for the first processing device a print instruction having a description format corresponding to the substitute second processing device.

18. The storage medium according to claim 17, wherein the processing further comprises determining whether the processing based on the print instruction acquired from a previous process can be executed by its own process, and when it is determined that the process cannot be executed, notifying a processing device having executed the previous process that the processing cannot be executed.

19. The storage medium according to claim 18, wherein the processing further comprises notifying, when processing based on the print instruction acquired from a previous process has been normally completed in its own process, the processing device having executed the previous process that the processing has been normally completed.

20. A computer-readable storage medium storing a print processing program executable by a computer to process at least a portion of a printing process in a printing system for processing a print job based on a first print instruction in which request items in a printing process for acquiring a printed matter are described by a first description format, or on a second print instruction in which request items are described by a second description format that differs from the first description format, the print processing comprising:
interpreting the first print instruction acquired from a previous process;
outputting the first print instruction to a first processing device responsible for a predetermined process, and after completion of processing by the first processing device, determining whether a first processing device that is to perform a subsequent process is capable of executing processing; and
outputting the first print instruction to the first processing device that is to perform the subsequent process when the first processing device that is to perform the subsequent process is capable of executing, and when the first processing device that is to perform the subsequent process is not capable of executing, outputting the second print instruction to a second processing device that is capable of executing processing that is at least substantially the same as subsequent processing and that interprets the second print instruction and executes a predetermined process.

21. The storage medium according to claim 20, wherein the processing further comprises determining whether the processing based on the print instruction acquired from a previous process can be executed by its own process, and when it is determined that that the process cannot be executed, notifying a processing device having executed the previous process that the processing cannot be executed.

22. The storage medium according to claim 21, wherein the processing further comprises notifying, when processing based on the print instruction acquired from a previous process has been normally completed in its own process, the processing device having executed the previous process that the processing has been normally completed.

23. The storage medium according to claim 20, wherein the outputting comprises, when the first processing device that is to perform a subsequent process is not capable of executing processing, searching for a second processing device that is capable of executing processing that is at least substantially the same as subsequent processing and that interprets the second print instruction and executes a predetermined process.

24. The storage medium according to claim 20, wherein the outputting comprises, when the first processing device that is to perform a subsequent process is not capable of executing processing, converting the first print instruction to the second print instruction.

25. A printing system for processing a print job based on a print instruction in which request items in a printing system for obtaining a printed matter are described by a predetermined description format, the printing system comprising:
a plurality of processing devices for processing at least a portion of the printing process,
wherein the print processing devices being connected to each other, each print processing device comprises:
a determination section that, based on the print instruction acquired from a previous process, determines whether a first processing device that is to perform a subsequent process is capable of executing processing; and
an output section that, when the first processing device is capable of executing processing, outputs the print instruction to the first processing device, and when the first processing device is not capable of executing processing, outputs, to a second processing device that can be substituted for the first processing device, a print instruction corresponding to the substitute second processing device.

26. A printing system for processing a print job based on a print instruction in which request items in a printing process for obtaining a printed matter are described by a predetermined description format, the printing system comprising:
a plurality of printing processing devices for processing at least a portion of the printing process,
wherein the print processing devices being connected to each other, each print processing device comprises:
an interpretation section that interprets the first print instruction acquired from a previous process;
a determination section that outputs the first print instruction to a first processing device responsible for a predetermined process, and after completion of processing by the first processing device, the determination section determines whether or not a first processing device that is to perform a subsequent process is capable of executing processing; and
an output section that, when the first processing device that is to perform a subsequent process is capable of executing processing, outputs the first print instruction to the first processing device that is to perform a subsequent process, and when the first processing device that is to perform a subsequent process is not capable of executing processing, outputs the second print instruction to a second processing device that is capable of executing processing that is at least substantially the same processing as subsequent processing and that interprets the second print instruction and executes a predetermined process.
